(19) United States
(12) Patent Application Publication
(10) Pub. No.: US 2026/0258306 A1
(43) Pub. Date: Sep. 3, 2026

(54) PRODUCTION OF SUSTAINABLE HIGH-QUALITY OILS OF WHITE MINERAL OIL PURITY THROUGH TREATMENT OF RE-REFINED BASE OILS

(71) Applicant: HollyFrontier LSP Brand Strategies LLC, Dallas, TX (US)

(72) Inventors: Matthew Joyce, Dallas, TX (US); John Pudelski, Dallas, TX (US); Sander Engelsma, Dallas, TX (US); Rumeysa Caliskan, Dallas, TX (US)

(73) Assignee: HollyFrontier LSP Brand Strategies LLC, Dallas, TX (US)

(21) Appl. No.: 19/555,281

(22) Filed: Mar. 3, 2026

Related U.S. Application Data
(60) Provisional application No. 63/765,869, filed on Mar. 3, 2025.

(51) Int. Cl. C10G 25/00; C10G 17/06

(52) U.S. Cl. CPC C10G 25/006; C10G 17/06; C10G 25/003; C10G 2400/14

(57) ABSTRACT

High-quality oil meeting EP/USP specifications for white mineral oil purity can be obtained through treatment of re-refined base oil as described herein, using sulfonation treatments and bleaching material. The resulting high purity oil is sustainable with a reduced carbon footprint relative to oils meeting white mineral oil purity standards prepared from traditional starting materials.

This application claims priority to U.S. Provisional Patent App. No. 63/765,869, entitled “Production of Sustainable High-Quality Oils of White Mineral Oil Purity Through Treatment of Re-Refined Base Oils,” filed Mar. 3, 2025, the entire contents of which are hereby incorporated by reference.

### BACKGROUND

The present disclosure relates to the production of high-quality oils meeting white mineral oil purity standards with reduced carbon footprints by treatment of re-refined base oils.

A product's carbon footprint is the amount of CO₂ generated in the production of a fixed quantity of that product. The petroleum industry generally has a large carbon footprint due to greenhouse gas emissions released during oil and gas extraction, refining, transport, and combustion. Regulators and consumers are currently focused on methods to generate petroleum products that involve lower carbon footprints and are more environmentally friendly and sustainable.

Re-refined base oils are produced through a process that takes used motor oil or other used lubricants and refines it to remove contaminants and restore its original properties. Because of this manufacturing method, re-refined base oils have product carbon footprints that can be 40-80% improved vs. producing virgin base oils. Because of their improved carbon footprints, re-refined base oils are increasingly used in products and applications where there is a desire to demonstrate improved sustainability and are increasingly sought by customers who value this sustainability.

However, despite stringent refining, re-refined base oils do not generally meet the stringent purity requirements of the European and US pharmacopeia (EP/USP) which would allow these oils to be used in pharmaceutical applications, personal care and cosmetics and Industrial applications that require high purity and stability. Oils meeting the high purity standards for white mineral oils generally cannot be produced using current refining methods for re-refined base oils. The high purity of white mineral oils gives them increased commercial value compared to less pure oils. Industries that seek high purity oils for certain applications, including use in certain polymer formulations and those requiring compressor lubricants, also favor white mineral oils over less pure varieties. While these industries would prefer to use oils with lower carbon footprints, they cannot make use of the more sustainable re-refined base oils because the oils do not meet the high standards for white mineral oil purity required by EP/USP.

What is needed is a method for producing high-quality and high purity oils through treatment of re-refined base oils to produce sustainable oils with reduced carbon footprints that also meet the purity standards for white mineral oils.

### SUMMARY

The present disclosure pertains to the sustainable production of high-quality oils from re-refined base oils, and particularly to methods for purifying re-refined base oils to a degree that the resulting mineral oil meets EP/USP purity demands for white mineral oils. The high-quality, high purity oils produced by the present methods have significantly reduced carbon footprints relative to the carbon footprints of white mineral oils prepared using a conventional starting material, other than a re-refined base oil.

Customers in many applications, including those that require white mineral oils, are seeking products with improved carbon footprints. None of the re-refined base oils that were evaluated as described below met the EP/USP purity specifications for white mineral oils. Described herein are methods to purify re-refined base oils so that they meet the aforementioned purity requirements. These methods are advantageous because the products produced have the carbon footprint benefits of re-refined base oils and unexpected because the purity of the resulting oils is very high.

In preferred embodiments, the method described herein includes SO₃ and/or oleum treatment and bleaching of a re-refined base oil to produce a white mineral oil quality product meeting the EP/USP purity specifications.

### BRIEF DESCRIPTION OF THE DRAWINGS

FIG. 1 shows amounts of various species of polycyclic aromatic hydrocarbons (PAHs) found in a representative commercially-available re-refined base oil (RRBO) and in a white mineral oil quality product prepared by treatment of the commercially available RRBO according to preferred embodiments of methods described herein.

### DETAILED DESCRIPTION OF PREFERRED EMBODIMENTS

The present disclosure relates to production of sustainable high-quality, high purity oils through treatment of re-refined base oils. The methods disclosed herein produce EP/USP white mineral oil purity compliant oils with carbon footprint advantages from re-refined base oil. High purity mineral oils have utility in a wide variety of applications, including—but not limited to—pharma, personal care, compressor lubricants, polymer formulations and cosmetics.

In preferred embodiments, the methods disclosed herein utilize re-refined base oils. As used herein, the term “re-refined base oil” means a base oil made from used motor oil or other used lubricants that has been treated or refurbished to remove contaminants. Re-refined base oil producers typically receive used oils that are collected from many different sources, including motor oil, hydraulic fluids, gear oils, transmission fluids and more. A re-refined base oil has already been subjected to one or more refinement processes, such as dehydration, de-fueling, distillation, hydrotreating and solvent extraction/dewaxing and is considered a sustainable, reusable resource. The treatment steps used to restore the used oil to a higher quality base oil produce less carbon dioxide and thus provide a smaller carbon footprint than the higher quality base oil would have if it was obtained from an original source. Preferred embodiments utilize re-refined base oils with relatively lower amounts of aromatic content to be removed, such as American Petroleum Institute (API) G2 (Group II) or API G3 (Group III) re-refined base oils, which have been subjected to more severe refinement processes at higher pressure and heat. API G2 base oils generally contain greater than 90 percent saturates, less than 0.03 percent sulfur, and have a viscosity index between 80 to 120. API G3 base oils preferably contain greater than 90 percent saturates, less than 0.03 percent sulfur and have a viscosity index above 120. An API G1 base oil typically has less than 90 percent saturates, has been only solvent-refined, and is likely to contain a higher concentration of unsaturated molecules, including aromatic hydrocarbons. However, if the re-refined base oil has a high aromatic content (greater than 1-3%), such as an API G1 base oil, additional refinement can be achieved by multiple applications of the treatment steps disclosed herein to obtain the desired high purity oils. Re-refined base oils are available commercially from various suppliers.

Preferred embodiments of the methods described herein first utilize a sulfonation treatment, such as treatment with one or more of SO₃ gas, oleum and sulfuric acid, of the re-refined base oil. The sulfonation treatment may include one or more steps. Oleum is a liquid made up of concentrated sulfuric acid and sulfur trioxide having the formula H₂S₂O₇. In some embodiments, the re-refined base oil may first be sulfonated with SO₃ gas to produce a semi-refined intermediate oil and the intermediate oil may then be subjected to a further oleum treatment. In preferred embodiments, oleum having a concentration of 15%-25% is used in an amount such that the weight percent of SO₃ in the oleum relative to the weight of the re-refined base oil being treated is about 2-5%. In preferred embodiments, during the oleum treatment step, the reaction mixture is heated to about 50° C. and the reaction is allowed to continue for about 60 to 75 minutes. Reaction progress is preferably monitored by following the exotherm and allowing the reaction to proceed to completion. The sulfonation treatment step(s) results in the sulfonation of the re-refined base oil starting material. After the sulfonation reaction is completed, the reaction mixture is preferably centrifuged to separate an acid tar layer from an acid oil layer. The acid oil layer is retained for further processing.

In preferred embodiments, the acid oil layer obtained following either or any of the SO₃ and/or oleum treatment steps, or treatment with sulfuric acid, may be neutralized. The acid oil layer may be measured to obtain a total acid number, sulfonate count, and amount of sulfuric acid. This allows calculation of the components needed for neutralization, such as by using aqueous soda solution such as Na₂CO₃. After neutralization and settling, the oil layer is again retained for further processing.

In additional preferred embodiments, the sulfonated and neutralized oil layer is then mixed with or filtered through a bleaching material. The bleaching material may be bauxite, bentonite, sepiolite, attapulgite (palygorskite), kaolinite, montmorillonite, or any other suitable bleaching earth or substrate, or combinations thereof. In preferred embodiments approximately 2-10% bleaching earth by weight of the neutralized oil layer is added to the neutralized oil layer and the mixture is stirred for a period of time. The bleaching earth can then be removed by filtration to produce a high-quality white mineral oil meeting the EP/USP purity standards and having a reduced carbon footprint.

The steps in preferred embodiments of the methods described herein are preferably performed at atmospheric pressure and may be performed at any suitable temperature typically used for these types of treatment steps. In some preferred embodiments, the treatment with oleum may be performed at an elevated temperature of about 40-60° C.—and the bleaching step may be performed at an elevated temperature of about 40-80° C.

As used herein, the term “white mineral oil” refers to a mineral oil meeting the published EP/USP purity standards for white mineral oils. These purity standards include standards for the amount of polycyclic aromatic hydrocarbons (PAHs), which must be less than 0.1. The readily oxidizable substances (R.O.S.) must also be less than 1.0. The Saybolt color test of the oil must also be equal to or greater than 30 for it to qualify as a white mineral oil. Preferred embodiments described herein relate to high-quality oils that are prepared by processing and purifying re-refined base oils according to preferred methods described herein until the resulting oil meets the high purity standards for a white mineral oil.

As used herein, the term “reduced carbon footprint” means a carbon footprint that is reduced relative to conventional or traditional means of preparation. The purified oils described herein have a reduced carbon footprint relative to white mineral oils prepared according to traditional methods that do not use re-refined base oils as a starting material.

Accordingly, preferred embodiments described herein relate to a method for purifying a re-refined base oil to produce a purified oil having a reduced carbon footprint and meeting purity standards for white mineral oils. The method includes a step of performing a sulfonation treatment on a re-refined base oil to produce a sulfonated oil, wherein the re-refined base oil is derived from used oil or other used lubricants and a step of combining the sulfonated oil with a bleaching material to produce a purified oil having a reduced carbon footprint and meeting purity standards for white mineral oils, wherein the purified oil comprises less than 0.1% polycyclic aromatic hydrocarbons. In certain preferred embodiments, the re-refined base oil includes greater than 90% saturates, less than 0.03% sulfur, and less than 3% aromatic content. In other preferred embodiments, the re-refined base oil comprises less than 90% saturates and greater than 0.03% sulfur.

In preferred embodiments of the method described herein, the bleaching material is bauxite, bentonite, sepiolite, attapulgite, kaolinite, montmorillonite, or combinations thereof. The sulfonation treatment may comprise treatment with SO₃ gas, oleum, sulfuric acid, or combinations thereof. In certain preferred embodiments, the sulfonation treatment comprises treatment with oleum, the oleum comprises SO₃, and the oleum is combined with the re-refined base oil in an amount that provides SO₃ at about 2 to 5 weight percent of the re-refined base oil.

In additional preferred embodiments, the sulfonation treatment includes performing one or more sulfonation treatments on the sulfonated oil, before combining the sulfonated oil with the bleaching material. In additional preferred embodiments, one or more additional steps of combining the sulfonated oil with the bleaching material may be used, to produce intermediate purified oils prior to producing the purified oil having a reduced carbon footprint and meeting purity standards for white mineral oils. The sulfonation treatment and bleaching steps may each be repeated or alternated with each other and repeated as many times as desired to obtain an oil having the requisite purity. Repeating the steps is of particular benefit when using a re-refined base oil containing a greater amount of aromatic content or a lesser amount of saturates.

Additional preferred embodiments relate to the purified oil having a reduced carbon footprint and meeting purity standards for white mineral oils prepared by the method described here. Further preferred embodiments relate to a purified oil having a reduced carbon footprint and meeting purity standards for white mineral oils derived from re-refined base oil. In additional preferred embodiments, the purified oil having a reduced carbon footprint and meeting purity standards for white mineral oils comprises re-refined base oil that has been subjected to sulfonation with one or more of SO₃ gas, oleum, and sulfuric acid, and bleaching.

### Example 1

Re-refined base oil Kleen+ RHT 70 (SafetyKleen, Norwell, MA) (997 g) was sulfonated with 4.5 w % SO₃ gas (43.7 g). Reaction progression was monitored by following the exotherm, indicating completion after 60 minutes. The acid oil was transferred and centrifuged for 8 minutes, resulting in separation between the acid tar and acid oil. The acid oil layer was isolated. A soda solution (16 m %) was added to the acid oil under stirring (300 rpm) at 65° C., until the solution reached PH 8. Subsequently, 40 m % of an isopropyl alcohol (IPA):H₂O (55:45) solution was added. The mixture was transferred to a separation funnel, where two clear layers formed within 5 minutes. The top oil layer was isolated and heated to 105° C. for 1 hour to evaporate off the water and IPA, providing the semi-refined Kleen+ RHT 70 oil (940, 94%) as an intermediate.

The intermediate oil (425 g, 1 eq.) was oleum-treated by the addition of 108.5 g 25% oleum (27.1 g SO₃) at 50° C. Reaction progression was monitored by following the exotherm, indicating completion after 90 minutes. The reaction mixture was transferred and centrifuged for 8 minutes, resulting in separation between acid tar and acid oil.

At 65° C. a 30 v % 55:45 IPA:H₂O washing mixture including 25 mL soda (16 w % Na₂CO₃) was used to neutralize the separated acid oil layer. Once a pH of 8 was reached the mixture was left to settle at 65° C. for 6 minutes, after which a clear separation was visible. The layers were separated, and the top layer containing the treated oil was mixed with 5 m % bleaching earth (a mixture of bentonite, sepiolite, attapulgite) for one hour at 105° C. to remove any impurities. After filtration, a colorless oil was isolated (357 g, 84%). The product obtained was a mixture of saturated hydrocarbons from re-refined origin. The properties as measured are depicted in Table 1 below.

TABLE 1

| | | Untreated | Treated | |
|---|---|---|---|---|
| Parameter | Unit | (RHT 70) | (RHT 70) | Specs |
| Viscosity 40° C. | mm²/s | 12.7 | 12.8* | 10-14 |
| Viscosity 100° C. | mm²/s | 3.1 | 3.13 | 2-4 |
| Density 20° C. | kg/m³ | 839.4 | 832.4* | 825-850 |
| Flash point | Min ° C. | 184 | 184 | 165 |
| Pour point | ° C. | N.D. | ≤21 | ≤−6 |
| P.A.H. (EP) | — | >0.1 | 0.0707* | <0.1 |
| R.O.S. | — | ≥1.2 | 0.6* | <1.0 |
| Saybolt color | — | 6 | +30* | >30 |

It can be seen in Table 1 that after treatment in accordance with the exemplary method described above, the amount of PAHs in the re-refined base oil decreased from >0.1 to 0.0707 and the readily oxidizable substances decreased from greater than 1.2 to 0.6 and the final Saybolt color was +30. The asterisks indicate measurements within the specific ranges for a WMO product, specifically EP Monograph 0240, “Paraffin, Light Liquid”. Thus, the treatment described in this example produced a final treated product meeting the purity requirements of a white mineral oil (WMO).

### Example 2

Re-refined oil Kleen+ RHT 120 (SafetyKleen, Norwell, MA) (597 g) was sulfonated by addition of 80 g 25% oleum (20 g SO₃) at 50° C. Reaction progression was monitored by following the exotherm, indicating completion after 75 minutes. The reaction mixture was transferred and centrifuged for 8 minutes, resulting in separation between acid tar and acid oil. The acid oil was measured to obtain the Total Acid Number, Sulfonate Count and Sulfuric Acid to calculate the soda amount needed for neutralization and solvent for later extraction. At 65° C. a 30 v % 55:45 IPA:H₂O washing mixture including 30 mL soda (16 w % Na₂CO₃) was used to neutralize the acid oil. Once a pH of 8 was reached the mixture was left to settle at 65° C. for 10 minutes, after which a clear separation was visible. The layers were separated, and the top layer containing the treated oil was mixed with 5 m % bleaching earth (a mixture of bentonite, sepiolite, attapulgite) for one hour at 105° C. to remove any residual impurities. After filtration, 487 gram of purified oil was obtained, which corresponds to a yield of 82%. The product characteristics were determined, as shown below in Table 2, where Untreated refers to the characteristics of the starting material re-refined base oil and Treated refers to the characteristics of the final treated product.

TABLE 2

| | | Untreated | Treated | |
|---|---|---|---|---|
| Parameter | Unit | RHT 120 | RHT 120 | Specs |
| Viscosity 40° C. | mm²/s | 24.6 | 24.2 | 22.0-26.0 |
| Viscosity 100° C. | mm²/s | 4.8 | 4.79 | 4-6 |
| Density 20° C. | Kg/m³ | 839 | 837 | 850-870 |
| Flash point | ° C. | N.D. | 188 | 180 |
| R.O.S. | — | >1.2 | <0.2 | <1 |
| PAHs (EP) | — | 3.812 | 0.031 | <1.0 |
| Saybolt color | AU | >1.2 | +30 | >30 |

Of note, the final treated oil product passed the EP purity tests as described in EP Monograph 0240, “Paraffin, Light Liquid,” shown in Table 2 above. Changes in the R.O.S., amount of PAHs, and Saybolt color were all significant and the resulting treated product qualified as a WMO.

### Example 3

Re-refined base oil Avista KS150 (Avista Oil, Uetze, Germany) (388 g, 1 eq.) was sulfonated by addition of 96.7 g 25% oleum (20.1 g SO₃) at 50° C. Reaction progression was monitored by following the exotherm, indicating completion after 90 minutes. The reaction mixture was transferred and centrifuged for 8 minutes at 1650 rpm, resulting in separation between acid tar and acid oil (313 g).

At 65° C. a 55:45 IPA:H₂O washing mixture including 30 mL soda (16 w % Na₂CO₃), 12 mL H₂O and 52 mL IPA was used to neutralize the acid oil. Once a pH of 8 was reached, 20 mL of IPA was added and the mixture was left to settle at 65° C. A clear separation was visible after 8 minutes. The top oil layer was isolated and heated to 105° C. under constant stirring to evaporate of the IPA. The oil (296 g) was subsequently mixed with 5 m % bleaching earth (a mixture of bentonite, sepiolite, attapulgite) for one hour at 105° C. to remove remaining impurities. After filtration, the yield was recorded (263 g, 68%) alongside the product data as shown below (Table 3). The data from the base oil is also shown for comparison purposes. The properties as measured are depicted in Table 3 below.

TABLE 3

| | | Untreated | Treated | |
|---|---|---|---|---|
| | | (Avista | (Avista | |
| Analysis | Unit | KS150) | KS150) | Specs |
| Viscosity 40° C. | mm²/s | 32.9 | 31.2 | 28.0-33.0 |
| Viscosity 100° C. | mm²/s | 5.8 | 5.70 | 4.0-6.0 |
| Density 20° C. | kg/m³ | 840 | 840.3 | 845-875 |
| Flash point | ° C. | 238 | 236 | >180 |
| Pour point | ° C. | N.D. | −12 | Max −9 |
| P.A.H. (EP) | — | >0.1 | 0.0212 | Max 0.10 |
| R.O.S. | — | ≥1.2 | 0.5 | Max 1.0 |
| Saybolt color | — | −16 | +30 | Min 30 |

As seen in Table 3, the PAHs, R.O.S., and Saybolt color were all significantly changed following the exemplary treatment described in this example. The finished product met the EP/USP standards for purity of a white mineral oil.

### Example 4

Group 1 re-refined base oils YUNIGREEN SN150, SN300, and SN500P (Yunigreen, Yanbu, Saudi Arabia) were used to obtain white mineral oil purity oils according to exemplary methods described herein. The physical properties of the re-refined base oils (RRBO's) YUNIGREEN SN150, SN300, and SN500P were measured and are shown below in Table 4.

TABLE 4
Physical Parameters of RRBO's

| Analysis | Unit | YG150 | YG300 | YG500 |
|---|---|---|---|---|
| Viscosity | mm²/s | 31.1 | 54.9 | 63.1 |
| 40° C. | | | | |
| Viscosity | mm²/s | 5.44 | 7.94 | 8.70 |
| 100° C. | | | | |
| Density | kg/m³ | 856.3 | 861.7 | 862.0 |
| 20° C. | | | | |
| Refractive | — | 1.4730 | 1.4755 | 1.4754 |
| Index | | | | |
| <C₂₅ % | % | 16.3 | 6.7 | 2.2 |
| UVA | — | 1067 | 905 | 561 |

Treatment of YUNIGREEN SN150. YUNIGREEN SN150 (448 g) was sulfonated with 4.5 w % SO₃ gas, 1.8 eq. Reaction progression was monitored by following the exotherm, indicating completion after 60 minutes. The acid oil was transferred and centrifuged for 8 minutes (1650 rpm), resulting in separation between the acid tar (3.3 g, 0.7%) and acid oil. A portion of the acid oil was used for further workup (223 g, 49.7% of total), and the correction factor based on mass balance was used to calculate yields further in the method.

At 65° C. a 40 m % 55:45 IPA:H₂O washing mixture including 15 mL soda (16 w % Na₂CO₃) was used to neutralize the acid oil. Once a pH of 8 was reached the mixture was left to settle at 65° C. for 7 minutes, after which the layers separated. The bottom phase, containing the sulfonates, was desalted to remove excess water. Residual IPA was subsequently removed from both layers by evaporation at 105° C., affording 212 g (426 g corrected) of T1 oil and 8.3 g (16.7 g corrected) of sodium sulfonate, corresponding to yields of 95.5% and 3.7%, respectively.

To account for material losses during mass transfer a correction factor was applied. The recalculated mass balance is shown below in Table 5.

TABLE 5
Mass balance (re)calculation of YG150 SO₃ treatment

| | |
|---|---|
| Mass Input | Mass Output |

| | | | |
|---|---|---|---|
| Oil | 447.8 | Acid Tar | 3.3 |
| SO₃ | 20.5 | T1 Oil | 468.3 |
| | | Sulfonate | 16.7 |
| Total: | 468.3 | Total: | 446.4 (95.3%) |

The physical properties of the stage 1 (T1) oil were measured and are shown below in Table 6, with the base oil properties shown for comparison.

TABLE 6
Physical parameters YG150 base oil and T1 oil

| Analysis | Unit | YG150 | YG150-T1 |
|---|---|---|---|
| Viscosity 40° C. | mm²/s | 31.1 | 30.6 |
| Viscosity 100° C. | mm²/s | 5.44 | 5.45 |
| Density 20° C. | kg/m³ | 856.3 | 852.3 |
| Refractive Index | — | 1.4730 | 1.4700 |
| <C₂₅ % | % | 16.3 | 13.4 |
| UVA | — | 1067 | 69 |

The UVA was decreased by 1000 points, indicating close to full removal of non-MOSH impurities.

### Oleum Treatment of YuniGreen SN150 T1

YuniGreen SN150 T1 (362 g) was sulfonated by addition of 109.3 g 25% oleum (27.3 g SO₃) at 50° C. Reaction progression was monitored by following the exotherm, indicating completion after 90 minutes. The reaction mixture was transferred and centrifuged for 8 minutes (1650 rpm), resulting in separation between acid tar and acid oil (327 g).

At 65° C. a 55:45 IPA:H₂O washing mixture including 25 mL soda (16 w % Na₂CO₃), 19 mL H₂O and 54 mL IPA was used to neutralize the acid oil. Once a pH of 8 was reached the mixture was left to settle at 65° C. A clear phase separation was observed after 15 minutes, after which the layers were separated. Following evaporation of the IPA, the top oil layer (320 g) was treated with 10 wt % bleaching earth at 105° C. for 1 hour to remove residual impurities.

After filtration, the WMO yield was recorded (265 g, 73%) alongside the product data as shown below in Table 7. In Table 7, PAHs, Saybolt color and the sulfuric acid test are the key EP/UPS purity requirements. The obtained WMO passed in all characteristics. Base oil and T1 properties are shown for comparison. Properties of a commercially available WMO product are also shown as a WMO reference (WMO Ref.).

TABLE 7
The physical parameters of WMO Quality Product from YuniGreen SN150

| | | Base oil | T1 | WMO | |
|---|---|---|---|---|---|
| Analysis | Unit | (YG150) | (YG150) | (YG150) | WMO Ref. |
| Viscosity 40° C. | mm²/s | 31.1 | 30.6 | 26.9 | 28-33 |
| Viscosity 100° C. | mm²/s | 5.44 | 5.45 | 5.44 | 4-6 |
| Density 20° C. | kg/m³ | 856.3 | 852.3 | 850.9 | 845-875 |
| Refractive Index | — | 1.4730 | 1.4700 | 1.4693 | — |
| <C₂₅ % | % | 16.3 | 13.4 | 12.3 | — |
| Flash point | ° C. | — | — | 204 | ≥180 |
| Pour point | ° C. | — | — | −9 | ≤−9 |
| Sulfuric acid test | — | Fail | Fail | 0.0 | <1.0 |
| Saybolt color | Say | Fail | Fail | 30 | ≥30 |
| PAHs | AU | Fail | Fail | 0.011 | <0.1 |

YuniGreen SN150 WMO was obtained with high purity, comfortably passing key EP/UPS purity requirements (PAHs, Say, Sulfuric acid), proving that the methods described herein can produce white mineral oil quality oils from re-refined base oils. Physical characteristics of the resulting oil were similar to the WMO reference.

Treatment of YUNIGREEN SN300. YuniGreen SN300 (444 g) was sulfonated with 4.5 w % SO₃ gas, 1.8 eq. Reaction progression was monitored by following the exotherm, indicating completion after 60 minutes. The acid oil was transferred and centrifuged for 8 minutes (1650 ppm), resulting in separation between the acid tar (20.7 g, 4.9%) and acid oil. A portion of the acid oil was used for further workup (228 g, 54.5% of total), and the correction factor based on mass balance was used to calculate yields further in the method.

At 65° C. a 40 m % 55:45 IPA:H₂O washing mixture including 15 mL soda (16 w % Na₂CO₃) was used to neutralize the acid oil. Once a pH of 8 was reached the mixture was left to settle at 65° C. for 7 minutes, after which the layers were separated. Evaporation of IPA at 105° C. from both layers provided 208.4 g (382.4 g corr.) T1 oil and 10.7 g (19.6 g corr.) sodium sulfonate, corresponding to 90.5% and 4.6% yield. The sulfonate product had a measured sulfonate content of 74%.

To account for material losses during mass transfer a correction factor was applied. The recalculated mass balance is shown below in Table 8.

TABLE 8
Mass balance (re)calculation of YG300 SO₃ treatment

| | |
|---|---|
| Mass Input | Mass Output |

| | | | |
|---|---|---|---|
| Oil | 444 | Acid Tar | 20.7 |
| SO₃ | 19.2 | T1 Oil | 382.4 |
| | | Sulfonate | 19.6 |
| Total: | 463.2 | Total: | 422.7 (91.3%) |

The physical properties of the T1 oil were measured and are shown below in Table 9, with the base oil properties shown for comparison.

TABLE 9
Physical parameters YG300 base oil and T1 oil

| Analysis | Unit | YG300 | YG300-T1 |
|---|---|---|---|
| Viscosity 40° C. | mm²/s | 54.9 | 53.6 |
| Viscosity 100° C. | mm²/s | 7.94 | 7.88 |
| Density 20° C. | kg/m³ | 861.7 | 858.0 |
| Refractive Index | — | 1.4755 | 1.4730 |
| <C₂₅ % | % | 6.7 | 4.8 |
| UVA | — | 905 | 116 |

The UVA was decreased by 800 points, indicating the removal of most non-MOSH impurities.

### Oleum Treatment of YuniGreen SN300 T1

YuniGreen SN300 T1 (365 g) was sulfonated by addition of 74.9 g 25% oleum (12.0 g SO₃) at 50° C. Reaction progression was monitored by following the exotherm, indicating completion after 90 minutes. The reaction mixture was transferred and centrifuged for 8 minutes, resulting in separation between acid tar and acid oil (322 g).

At 65° C. a 55:45 IPA:H₂O washing mixture including 25 mL soda (16 w % Na₂CO₃), 19 mL H₂O and 54 mL IPA was used to neutralize the acid oil. Once a pH of 8 was reached the mixture was left to settle at 65° C. After 9 minutes the layers were separated. Following evaporation of the IPA, the top oil layer (310 g) was treated with 10 m % bleaching earth at 105° C. for 1 hour to remove remaining impurities.

After filtration the WMO yield was recorded (280 g, 77%) alongside the product data as shown below in Table 10. In Table 10, PAHs, Saybolt color and the sulfuric acid test are the key EP/UPS purity requirements, with the WMO (SN300) passing all requirements except for pour point. Base oil and T1 properties shown for comparison. WMO Ref. is the closest current commercially available WMO product.

TABLE 10
The physical parameters of WMO Quality Product from YuniGreen SN300

| | | RRBO | T1 | WMO | |
|---|---|---|---|---|---|
| Analysis | Unit | (YG300) | (YG300) | (YG300) | WMO Ref. |
| Viscosity 40° C. | mm²/s | 54.9 | 53.6 | 52.4 | 52-57 |
| Viscosity 100° C. | mm²/s | 7.94 | 7.88 | 7.77 | 6-8 |
| Density 20° C. | kg/m³ | 861.7 | 858.0 | 858.0 | 865-885 |
| Refractive Index | — | 1.4755 | 1.4730 | 1.4720 | — |
| <C₂₅ % | % | 6.7 | 4.8 | 5.7 | — |
| Flash point | ° C. | — | — | 238 | ≥200 |
| Pour point | ° C. | — | — | −6 | ≤−15 |
| Sulfuric acid test | — | Fail | Fail | 0.0 | <1.0 |
| Saybolt color | Say | Fail | Fail | 30 | ≥30 |
| PAHs | AU | Fail | Fail | 0.009 | <0.1 |

YuniGreen SN300 WMO passed key EP/UPS purity requirements (PAHs, Say, Sulfuric acid), proving that the methods described herein can produce white mineral oil quality oils from re-refined base oils. Physical characteristics of the resulting oil were similar to the WMO reference.

Treatment of YUNIGREEN SN500P. YUNIGREEN SN500P (678 g) was sulfonated with 4.5 w % SO₃ gas, 1.8 eq. Reaction progression was monitored by following the exotherm, indicating completion after 60 minutes. The acid oil was transferred and centrifuged for 8 minutes (1650 rpm), resulting in separation between the acid tar (36.4 g, 5.3%) and acid oil.

At 65° C. a 40 m % 55:45 IPA:H₂O washing mixture including 40 mL soda (16 w % Na₂CO₃) was used to neutralize the acid oil. Once a pH of 8 was reached the mixture was left to settle at 65° C. for 9 minutes, after which the layers were separated. The IPA was removed from the oil phase by evaporation at 105° C. under stirring. The bottom phase, containing the sulfonates, was desalted to remove excess water. After phase separation, residual solvents were removed by evaporation at 105° C., yielding 604 g of T1 oil and 45.4 g of sodium sulfonate, corresponding to yields of 88.1% and 6.6%, respectively. The sulfonate product had a measured sulfonate content of 67%.

To account for material losses during mass transfer a correction factor was applied. The recalculated mass balance is shown below in Table 11.

TABLE 11
Mass balance (re)calculation of SN500P SO₃ treatment

| | |
|---|---|
| Mass Input | Mass Output |

| | | | |
|---|---|---|---|
| Oil | 678 | Acid Tar | 36.4 |
| SO₃ | 28.5 | T1 Oil | 603.8 |
| | | Sulfonate | 45.4 |
| Total: | 706.5 | Total: | 685.6 (97.0%) |

The physical properties of the T1 oil were measured and are shown below in Table 12, with the base oil properties shown for comparison.

TABLE 12
Physical parameters SN500P base oil and T1 oil

| Analysis | Unit | YG500P | YG500P-T1 |
|---|---|---|---|
| Viscosity 40° C. | mm²/s | 63.1 | 64.8 |
| Viscosity 100° C. | mm²/s | 8.70 | 8.95 |
| Density 20° C. | kg/m³ | 862.0 | 859.5 |
| Refractive Index | — | 1.4754 | 1.4734 |
| <C₂₅ % | % | 2.2 | 1.5 |
| UVA | — | 561 | 57 |

### Oleum Treatment of YuniGreen SN500P T1

YuniGreen SN500P T1 (583 g) was sulfonated by addition of 117.7 g 25% oleum (29.4 g SO₃) at 50° C. Reaction progression was monitored by following the exotherm, indicating completion after 90 minutes. The reaction mixture was transferred and centrifuged for 8 minutes (1650 rpm), resulting in separation between acid tar and acid oil (520 g).

At 65° C. a 55:45 IPA:H₂O washing mixture including 50 mL soda (16 w % Na₂CO₃), 20 mL H₂O and 86 mL IPA was used to neutralize the acid oil. Once a pH of 8 was reached the mixture was left to settle at 65° C. After 9 minutes the layers were separated. Following evaporation of the IPA, the top oil layer (499 g) was treated with 10 m % bleaching earth at 105° C. for 1 hour to remove remaining impurities.

After filtration, the WMO yield was determined (450 g, 77%) alongside the product data shown below in Table 13. In Table 13, PAHs, Saybolt color and the sulfuric acid test are the key EP/UPS purity requirements, with the WMO (SN500P) passing all requirements. Base oil and T1 properties shown for comparison. WMO Ref. is the closest current commercially available WMO product.

TABLE 13
The physical parameters of WMO Quality Product from YuniGreen SN500P

| | | RRBO | T1 | WMO | |
|---|---|---|---|---|---|
| Analysis | Unit | (YG500P) | (YG500P) | (YG500P) | WMO Ref. |
| Viscosity 40° C. | mm²/s | 63.1 | 64.8 | 64.5 | 63-70 |
| Viscosity 100° C. | mm²/s | 8.70 | 8.95 | 8.92 | 8.5-10 |
| Density 20° C. | kg/m³ | 862.0 | 859.5 | 857.9 | 850-880 |
| Refractive Index | — | 1.4754 | 1.4734 | 1.4730 | — |
| <C₂₅ % | % | 2.2 | 1.5 | 2.2 | <5.0 |
| Flash point | ° C. | — | — | 238 | ≥220 |
| Pour point | ° C. | — | — | −6 | ≤−6 |
| Sulfuric acid test | — | Fail | Fail | 0.0 | <1.0 |
| Saybolt color | Say | Fail | Fail | 30 | ≥30 |
| PAHs | AU | Fail | Fail | 0.011 | <0.1 |

YuniGreen SN500P WMO was obtained with high purity, passing key EP/UPS purity requirements (PAHs, Say, Sulfuric acid), proving that the methods described herein can produce white mineral oil quality oils from re-refined base oils. Physical characteristics of the resulting oil were similar to the WMO reference.

Tables 14 and 15 below show sulfur and chlorine impurities before and after treatment of RBBOs as determined by XRF, with values in ppm.

TABLE 14

| | YG150-BO | | YG150 WMO | | YG300-BO | | YG300 WMO | |
|---|---|---|---|---|---|---|---|---|
| | | Abs. | | Abs. | | Abs. | | Abs. |
| Element | Conc. | Error | Conc. | Error | Conc. | Error | Conc. | Error |
| Cl | 1.8 | 0.10 | 0.20 | 0.1 | 1.60 | 0.1 | 0.30 | 0.1 |
| S | 850 | 0.80 | 1.05 | 0.04 | 1352 | 1.0 | 13.10 | 0.1 |

TABLE 15

| | |
|---|---|
| YG500-BO | YG500 WMO |

| Element | Conc. | Abs. Error | Conc. | Abs. Error |
|---|---|---|---|---|
| Cl | 2.40 | 0.10 | 0.60 | 0.1 |
| S | 1259 | 1.0 | 11.3 | 0.1 |

### Example 5

UV stability analyses were conducted on re-refined base oil (RRBO) samples as well as white mineral oil quality products obtained using the methods described herein (WMOs). The UV testing methodology determined how petroleum products respond to UV exposure over a 24-hour period.

Methodology. A standard procedure for evaluating UV stability of petroleum products was employed. Approximately 30-50 mL of each sample, including controls, was distributed into 3-inch diameter quartz dishes. Control samples were wrapped in aluminum foil to simulate dark conditions, shielding them from UV exposure. Accelerated UV testing was performed using a Xenon Xe-1 Stability Chamber under the following conditions: irradiance of 1.00 W/m2 at 420 nm, chamber air temperature of 40° C., and a total exposure time of 24 hours divided into 4-hour intervals. Throughout the testing period, odor and visual color changes were evaluated at each 4-hour increment. Final color and odor readings were used to assess the extent of UV-induced changes and overall stability.

### UV Stability on RRBO Samples

Ten RRBO samples were analyzed from three different sources. SafetyKleen KLEEN+RHT70 RRBO Base Oil, SafetyKleen KLEEN+RHT70 RRBO WMO, Veolia VEO-150 RRBO Base Oil, and Veolia VEO-150 WMO were analyzed. SafetyKleen KLEEN+RHT70 RRBO WMO was obtained as described in Example 1 above. Six YuniGreen samples were analyzed, comprising three re-refined base oils (YG150A, YG300A, and YG500A) and three corresponding white mineral oil quality products, all prepared as described in Example 4 above (YG150B, YG300B, and YG500B).

To obtain Veolia VEO-150 WMO, VEO-150 RBBO (624 g, 1 eq.) was sulfonated by addition of 80.5 g 25% oleum (20.13 g SO₃) at 50° C. Reaction progression was monitored by following the exotherm, indicating completion after 75 minutes. The reaction mixture was transferred and centrifuged for 8 minutes, resulting in separation between acid tar and acid oil.

At 65° C. a 30 v % 55:45 IPA:H₂O washing mixture including 35 mL soda (16 w % Na₂CO₃) was used to neutralize the acid oil. Once a pH of 8 was reached the mixture was left to settle at 65° C. for 3 minutes, after which a clear separation was visible. The layers were separated, and the top layer containing the WMO was filtered through bleaching earth to remove any impurities. After filtration the yield was recorded alongside the product data as shown below in Table 16. The data from the base oil is also shown for comparison purposes.

TABLE 16
Physical parameters of VEO-150 WMO
product compared to the base oil

| | | Base oil | WMO | |
|---|---|---|---|---|
| Analysis | Unit | (VEO-150) | (VEO-150) | WMO Ref. |
| PAHs | — | >4.0 | 0.038 | <0.1 |
| Viscosity 40° C. | mm²/s | 28.6 | 28.2 | 28.0-35.0 |
| Viscosity 100° C. | mm²/s | 5.32 | 5.28 | 4.0-6.0 |
| Density 20° C. | Kg/m³ | 841.6 | 839.4 | 845-875 |
| Refractive Index | — | 1.4661 | 1.4650 | — |
| Flash point | ° C. | 220 | 232 | ≥180 |
| Pour point | ° C. | — | −19 | ≤−9 |
| Sulfuric acid test | — | >1.2 | 0.1 | 1.0 |
| Saybolt color | — | −16 | +30 | >30 |
| <C₂₅ % | % | 6.4 | 5.7 | — |

Initial Saybolt color assessments were conducted for each of the SafetyKleen and Veolia samples referenced above. Initial ASTM D1500 color for base oils and Saybolt color for WMOs were conducted for the YuniGreen samples. The ASTM D1500 color scale was applied to the YuniGreen base oils because it accommodates the broader yellow-to-red hue range characteristic of less-refined petroleum products. The Saybolt color scale was used for Safety-Kleen, Veolia, and all WMO samples, as it provides greater sensitivity to subtle yellowish tones in nearly colorless petroleum products.

After the first 4-hour cycle, base oil samples became oxidized and turned dark yellow compared to their respective control samples. Due to their failure to maintain UV stability, the SafetyKleen and Veolia base oil samples were excluded from further analysis. The YuniGreen base oil and all WMO samples were analyzed for the full 24-hour UV exposure period. The results are shown in Table 17 below.

TABLE 17
Color vs UV Exposure Results

| | | Color vs UV-Exposure | | |
|---|---|---|---|---|
| | | Ref. (0 h | | |
| Sample Description | Color Method | UV) | 4 h UV | 24 h UV |
| SafetyKleen RHT + 70 RRBO Base Oil | Saybolt | 13 | −16 | Stopped at 4 h |
| SafetyKleen RHT + 70 RRBO WMO | Saybolt | +30 | — | +30 |
| Veolia VEO-150 RRBO Base Oil | Saybolt | −16 | −16 | Stopped at 4 h |
| Veolia VEO-150 RRBO WMO | Saybolt | +30 | — | 22 |
| YG150 RRBO | ASTM 1500D | 2 | — | 6.5 |
| YG150 WMO | Saybolt | +30 | — | +30 |
| YG300 RRBO | ASTM 1500D | 2 | — | 6.5 |
| YG300 WMO | Saybolt | +30 | — | +30 |
| YG500 RRBO | ASTM 1500D | 2 | — | 6.5 |
| YG500 WMO | Saybolt | +30 | — | +30 |

Accelerated UV exposure testing revealed significant differences in stability between base oils and white mineral oil quality products (WMOs) obtained through the methods disclosed herein. All base oil samples exhibited rapid and severe degradation, including pronounced color darkening, and evidence of oxidation within the first four hours. In contrast, WMOs maintained their initial color and showed only minor odor changes, indicating superior UV stability. These results confirm that WMOs prepared using the methods described herein are substantially more resistant to UV-induced oxidation compared to untreated base oils, making them better suited for applications requiring prolonged light exposure.

### Example 6

Measurements of polycyclic aromatic hydrocarbons (PAHs) were conducted for pairs of re-refined base oil (RRBO) samples as well as white mineral oil quality products (WMO) obtained using from the RRBO samples using the methods described herein. Results are shown in the tables below. In the tables below, SK70 and SK120 refer to SafetyKleen KLEEN+RHT70 and SafetyKleen KLEEN+RHT120 base oils, respectively. VEO-150 refers to Veolia VEO-150 RRBO Base Oil. YG150, YG300, and YG500 refer to YUNIGREEN SN150, SN300, and SN500P RRBOs, respectively. Table 20 shows the results for Avista Green KERNSOLVAT® KS100, Avista Green KERNSOLVAT® KS150 (Avista Green, Denmark), Avista KERNSOLVAT® KS150, and Avista KERNSOLVAT® KS4 RRBOs (Avista, Germany) respectively.

The SafetyKleen WMO products were obtained as described in Example 1 and the Veolia WMO products were obtained as described in Example 5. The Avista Green and Avista WMO products were obtained as described below.

### Oleum Treatment of Avista Green KS100

Re-refined base oil Avista Green KERNSOLVAT® KS100 (426 g) was heated to 50° C. and treated with 64 g of 25 wt % oleum (corresponding to 16 g free SO₃). The addition resulted in a pronounced exotherm (temperature increase of 9° C.). Reaction completion was indicated by cessation of the exotherm after approximately 90 minutes. The reaction mixture was centrifuged for 8 minutes (1650 rpm) to afford an acid tar phase and an acid oil phase (376 g).

The acid oil phase was neutralized at 65° C. using an IPA/water washing mixture (55:45 v/v) containing aqueous sodium carbonate solution (16 wt %). After adjustment to approximately pH 8, the mixture was allowed to settle at 65° C. A clear phase separation was observed after approximately 8 minutes. The top oil phase was isolated and the solvent removed by evaporation at 105° C. The resulting oil (364 g) was treated with bleaching earth (5 wt %) at 105° C. for 1 hour and subsequently filtered to yield 350 g (82%) white mineral oil.

### Oleum Treatment of Avista Green KS150

Re-refined base oil Avista Green KERNSOLVAT® KS150 (490 g) was heated to 50° C. and treated with 77 g of 25 wt % oleum (corresponding to 19.25 g free SO₃). The addition resulted in a pronounced exotherm (temperature increase of 10° C.). Reaction completion was indicated by cessation of the exotherm after approximately 90 minutes. The reaction mixture was centrifuged for 8 minutes (1650 rpm) to afford an acid tar phase and an acid oil phase (435 g).

The acid oil phase was neutralized at 65° C. using an IPA/water washing mixture (55:45 v/v) containing aqueous sodium carbonate solution (16 wt %). After adjustment to approximately pH 8, the mixture was allowed to settle at 65° C. A clear phase separation was observed after approximately 20 minutes. The top oil phase was isolated and the solvent removed by evaporation at 105° C. The resulting oil (417 g) was treated with bleaching earth (5 wt %) at 105° C. for 1 hour and subsequently filtered to yield 380 g (78%) white mineral oil.

### Oleum Treatment of Avista KS4

Re-refined base oil Avista KERNSOLVAT® KS4 (552 g) was heated to 50° C. and treated with 86 g of 25 wt % oleum (corresponding to 21.5 g free SO₃). The addition resulted in a pronounced exotherm (temperature increase of 8° C.). Reaction completion was indicated by cessation of the exotherm after approximately 90 minutes. The reaction mixture was centrifuged for 8 minutes (1650 rpm) to afford an acid tar phase and an acid oil phase (510 g).

The acid oil phase was neutralized at 65° C. using an IPA/water washing mixture (55:45 v/v) containing aqueous sodium carbonate solution (16 wt %). After adjustment to approximately pH 8, the mixture was allowed to settle at 65° C. A clear phase separation was observed after approximately 6 minutes. The top oil phase was isolated and the solvent removed by evaporation at 105° C. The resulting oil (490 g) was treated with bleaching earth (5 wt %) at 105° C. for 1 hour and subsequently filtered to yield 454 g (82%) white mineral oil.

TABLE 18

| | SK70 | | SK120 | | VEO-150 | |
|---|---|---|---|---|---|---|
| | RRBO | WMO | RRBO | WMO | RRBO | WMO |
| TOTAL PAH | 512108 | 430 | 48284 | 144 | 28334 | 359 |
| (PPB) | | | | | | |
| PERCENT | | 99.9% | | 99.7% | | 98.7% |
| REDUCTION | | | | | | |

TABLE 19

| | YG150 | | YG300 | | YG500 | |
|---|---|---|---|---|---|---|
| | RRBO | WMO | RRBO | WMO | RRBO | WMO |
| TOTAL PAH | 265865 | 127 | 130130 | 121 | 24520 | 116 |
| (PPB) | | | | | | |
| PERCENT | | 99.95% | | 99.91% | | 99.53% |
| REDUCTION | | | | | | |

TABLE 20

| | Avista Green | | Avista Green | | Avista | | Avista | |
|---|---|---|---|---|---|---|---|---|
| | KernSolvat KS100 | | KernSolvat KS150 | | KernSolvat KS150 | | KernSolvat KS4 | |
| | RRBO | WMO | RRBO | WMO | RRBO | WMO | RRBO | WMO |
| TOTAL PAH | 4583 | 247 | 2867 | 234 | 1389 | 126 | 1004 | 235 |
| (PPB) | | | | | | | | |
| PERCENT | | 94.6% | | 91.8% | | 90.9% | | 76.6% |
| REDUCTION | | | | | | | | |

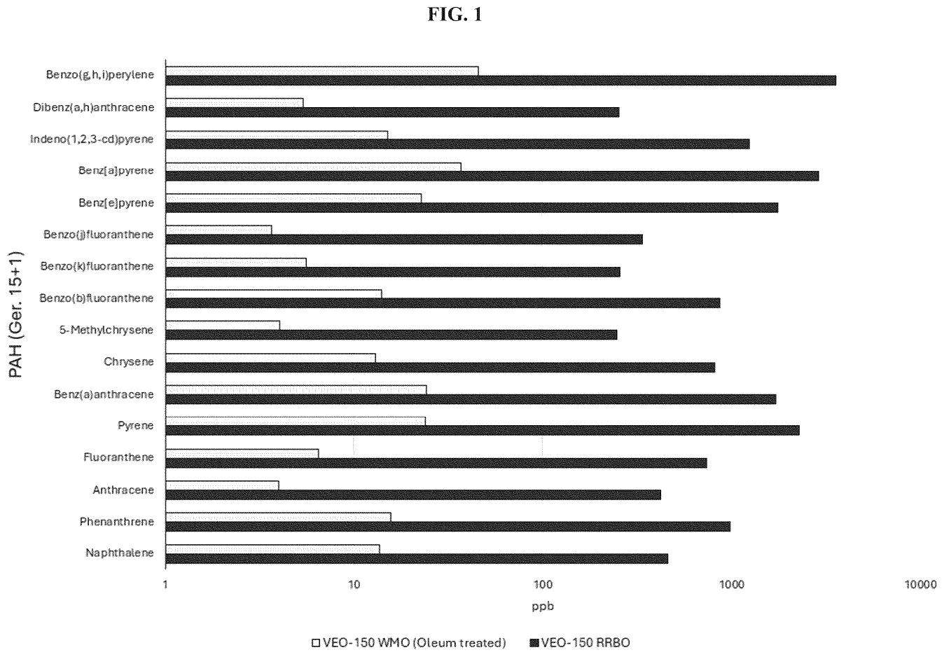

The percentage reduction in PAHs between the RRBO and the WMO obtained from treating the RRBO according to embodiments of methods described herein is significant. FIG. 1 show a breakdown of each species of PAH detected (according to the Ger. 15+1 PAH norm) in the Veolia VEO-150 RRBO and the WMO obtained through treatment with oleum according to preferred embodiments of methods described herein.

What is claimed is:

1. A method for purifying a re-refined base oil to produce a purified oil having a reduced carbon footprint and meeting purity standards for white mineral oils, comprising:
performing a sulfonation treatment on a re-refined base oil to produce a sulfonated oil, wherein the re-refined base oil is derived from used oil or other used lubricants; and
combining the sulfonated oil with a bleaching material to produce a purified oil having a reduced carbon footprint and meeting purity standards for white mineral oils, wherein the purified oil comprises less than 0.1% polycyclic aromatic hydrocarbons.

2. The method of claim 1, wherein the re-refined base oil comprises greater than 90% saturates, less than 0.03% sulfur, and less than 3% aromatic content.

3. The method of claim 1, wherein the re-refined base oil comprises less than 90% saturates and greater than 0.03% sulfur.

4. The method of claim 1, wherein the bleaching material is bauxite, bentonite, sepiolite, attapulgite, kaolinite, montmorillonite, or combinations thereof.

5. The method of claim 1, wherein the sulfonation treatment comprises treatment with SO₃ gas, oleum, sulfuric acid, or combinations thereof.

6. The method of claim 5, wherein the sulfonation treatment comprises treatment with oleum, wherein the oleum comprises SO₃, and wherein the oleum is combined with the re-refined base oil in an amount that provides SO₃ at about 2 to 5 weight percent of the re-refined base oil.

7. The method of claim 1, wherein the sulfonation treatment comprises performing one or more sulfonation treatments on the sulfonated oil, before combining the sulfonated oil with the bleaching material.

8. The method of claim 1, further comprising performing one or more additional steps of combining the sulfonated oil with the bleaching material to produce intermediate purified oils prior to producing the purified oil having a reduced carbon footprint and meeting purity standards for white mineral oils.

9. The purified oil having a reduced carbon footprint and meeting purity standards for white mineral oils prepared by the method of claim 1.

10. A purified oil having a reduced carbon footprint and meeting purity standards for white mineral oils derived from re-refined base oil.

11. The purified oil having a reduced carbon footprint and meeting purity standards for white mineral oils of claim 10, wherein the purified oil comprises re-refined base oil subjected to sulfonation with one or more of SO₃ gas, oleum, and sulfuric acid, and bleaching.
